(19) United States
(12) Patent Application Publication
(10) Pub. No.: US 2012/0296572 A1
(43) Pub. Date: Nov. 22, 2012

(54) SYSTEM AND METHOD FOR REAL-TIME SAMPLE ANALYSIS

(76) Inventors: Jeff Hess, Coto de Caza, CA (US); John Story, Katy, TX (US); Larry Gorman, Pismo Beach, CA (US); Greg Curtzwiler, Hattiesburg, MS (US); Keith Vorst, Atascadero, CA (US)

(21) Appl. No.: 13/429,181

(22) Filed: Mar. 23, 2012

Related U.S. Application Data
(60) Provisional application No. 61/466,764, filed on Mar. 23, 2011.

(51) Int. Cl. G01N 31/00; G06F 19/00

(52) U.S. Cl. 702/24

(57) ABSTRACT

A system for predicting the amount of VOCs in an extruded product includes a container holding a gaseous sample, a detector in communication with the container for analyzing the gaseous sample, and a processor in communication with the detector and programmed to analyze the data from the detector and predict the amount of VOCs in an extruded product. A method of predicting an amount of extractable volatile organic compounds in an extruded product includes delivering a sample of gas from an intermediate stage in an extrusion process to a detector, analyzing the sample of gas using the detector to obtain data about the amount of VOCs in the sample of gas, delivering the data to a processor, comparing the data to control data to generate comparison data, and predicting the amount of extractable VOCs in the extruded product.

### CROSS-REFERENCE TO RELATED APPLICATION

This application claims priority to and the benefit of U.S. Provisional Application No. 61/466,764, filed on Mar. 23, 2011, the entire contents of which are incorporated herein by reference.

### FIELD OF THE INVENTION

The present invention is directed to systems and methods for real-time sample analysis.

### BACKGROUND

Recycling plastics has become a popular way to reduce the harmful environmental impact of plastics. One method of recycling plastics is the extrusion of post-consumer plastic flake into various shapes for use in different applications. Post-consumer plastic flake is made by collecting plastic products (e.g., used plastic bottles or other packaging materials) and mechanically processing them to particles the size of flakes. However, this post-consumer material includes contaminants and/or volatile organic compounds that, over time, can leach out of the extruded material and into the product held in the packaging. This leaching is particularly problematic in extruded plastic that is used to hold food products, as such packaging is regulated by the federal government. Specifically, given the dangers associated with the leaching of chemicals from plastic packaging into food products, the Code of Federal Regulations limits the acceptable amount of such leaching. These limits vary depending on the nature of the compound containing the food product.

As post-consumer plastic materials often include contaminants and/or volatile organic components, it is difficult if not impossible to predict whether the extrusion of such post-consumer materials will result in an extruded product that meets the Code of Federal Regulations requirement. Given the inability to predict (prior to completing the extrusion process) whether a post-consumer material will result in an extruded material meeting the federal requirement, the extruded material is typically not tested for compliance until after the extrusion process is completed. However, when the extruded product fails to meet the federal regulations, that extruded product is wasted, which increases operation and material costs.

### SUMMARY

Embodiments of the present invention are directed to systems and methods for real-time sample analysis. Using the methods and systems of the present invention, the VOC level and compliance with federal regulations of a product can be predicted at various points throughout the manufacturing (e.g., extrusion) process. Indeed, using the systems and methods of the present invention to predict the VOC level and compliance with federal regulations, the waste generated from the completion of products that do not meet the federal regulations can be substantially prevented.

In embodiments of the present invention, a system for real-time sample analysis during extrusion includes an extrusion line having at least one sample source container holding a gaseous sample for analysis, at least one detector in communication with the sample source container and configured to receive and analyze the gaseous sample to generate data about the gaseous sample, and a processor in communication with the detector. The processor may be programmed to analyze the data about the gaseous sample and to predict an amount of volatile organic compounds in the extruded product based on the analysis of the data about the gaseous sample.

The sample source container can be any component of the extrusion line. For example, the sample source container may be a hopper, a crystallizer, a drier, a die, a take-up roller device, a barrel, a breaker plate, and/or a feedpipe.

In some embodiments, the detector is a flame ionization detector, a photoionization detector, and/or a mass spectrometer.

In some embodiments, the system may further include a chromatography column between the sample source container and the detector. One exemplary chromatography column is a gas chromatography column.

The system may further include a conduit connecting the sample source container to the detector. The conduit may be a pipe or tube, and may be made of any material, for example copper. Also, in some embodiments, the conduit is temperature controlled.

The system may further include a filter between the sample source container and the detector. The filter can be made of any suitable material, for example a polytetrafluoroethylene material.

In some embodiments, the system further includes a pump for pumping the gaseous sample from the sample source container to the detector. The system may also include a controller for controlling the delivery of power to the pump.

The system may also include a data transfer device in communication with the detector and the processor. The data transfer device is configured to receive the data from the detector and transfer the data to the processor. The data transfer device may be in communication with the processor by a wired or wireless connection.

In other embodiments, a method of predicting an amount of extractable volatile organic compounds in an extruded product includes delivering a sample of gas from at least one intermediate stage in an extrusion process to a detector, analyzing the sample of gas using the detector to obtain data about the amount of volatile organic compounds in the sample of gas, delivering the data to a processor, using the processor to compare the data to control data stored in the processor to generate comparison data, and based on the comparison data, predicting the amount of extractable volatile organic compounds in the extruded product.

In some embodiments, the delivering the sample of gas from the intermediate stage to the detector involves pumping the sample of gas from a sample source container in an extrusion line through a conduit to the detector. The sample of gas may be continuously pumped to the detector.

Alternatively, the sample of gas may be pumped or delivered to the detector at time intervals. In some embodiments, the sample of gas is delivered to the detector by pumping the sample of gas through a conduit to the detector using a pump connected to a controller. The controller controls delivery of power to the pump to turn the pump on and off according to the time intervals.

### BRIEF DESCRIPTION OF THE DRAWINGS

These and other features and advantages of the present invention will be better understood by reference to the following detailed description when considered in conjunction with the accompanying drawings, in which:

FIG. 1 is a schematic diagram of a system according to an embodiment of the present invention;

FIG. 2 is a schematic diagram of a system according to another embodiment of the present invention;

FIG. 3 is a schematic diagram of a system according to another embodiment of the present invention;

FIG. 4 is a schematic of a method according to an embodiment of the present invention; and

FIG. 5 is a schematic of a method of preparing an empirical model for use in the method of FIG. 4.

### DETAILED DESCRIPTION

Embodiments of the present invention are directed to a system for real-time sample analysis. In some embodiments, for example, the system includes novel plastic extrusion machinery that is capable of analyzing samples taken during the extrusion process, comparing the data from the analyzed samples to a baseline or threshold model, and based on that comparison, predicting whether the resulting extruded product is likely to meet federal desorbtion requirements, which vary depending on the compounds included in the package (for instance, the test required for recycled polyethylene terephthalate determines whether a product is likely to desorb less than 0.5 mg total chemicals per square inch into a food simulant). While the system is depicted and described herein with reference to plastic extrusion machinery and systems, it is understood that the system can be integrated in any manufacturing machinery or system in which real-time sample analysis is desirable. Additionally, although the system is described as useful in determining and/or predicting the level of contaminants and/or volatile organic compounds in an extruded recycled plastic material, it is understood that the system is useful in determining the level of contaminants and/or volatile organic compounds in other materials. Also, while the system is described as useful in determining levels of contaminants and/or volatile organic compounds, it is understood that the system could be used to determine the level of any other type of chemical or material.

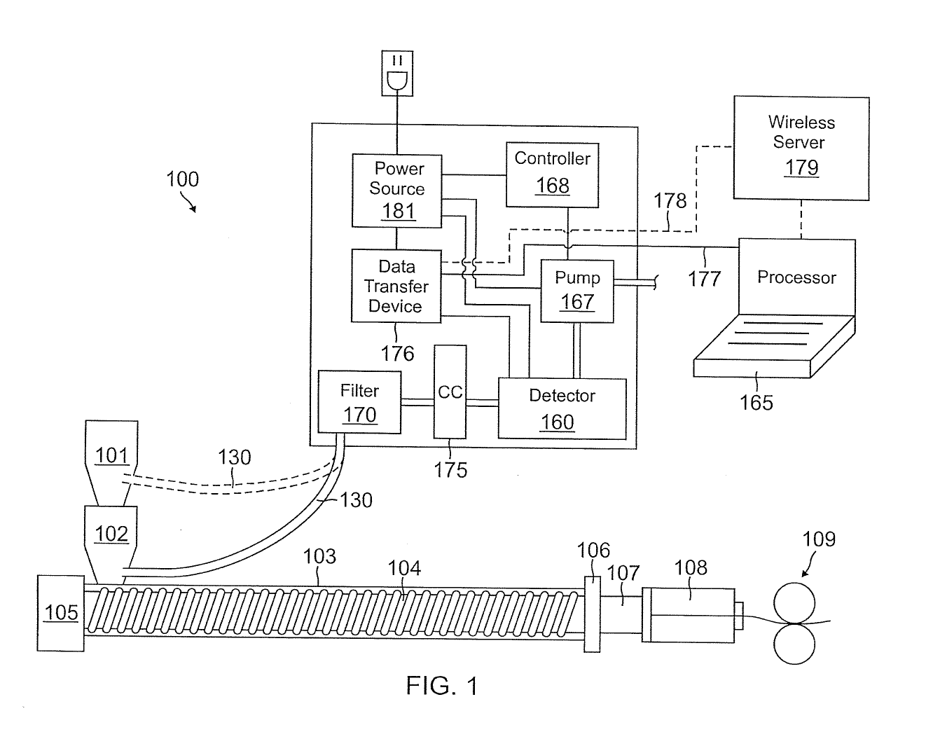

In some embodiments, as depicted generally in FIG. 1, a system 100 for real-time sample analysis includes a sample source container from which the sample is taken for analysis, a detector 160 for receiving the sample and generating sample data, and a processor 165 for analyzing the sample data. In the depicted embodiment, the system 100 includes a plastic extrusion line which includes a crystallizer/drier 101 for holding and drying a feedstock material, a hopper 102 in communication with the crystallizer/drier 101, a barrel 103 containing an extruder screw 104 and having one end in communication with the hopper 102, a screw motor 105 for driving the screw 104, a breaker plate 106 in communication with another end of the barrel 103, a feedpipe 107 in communication with the breaker plate 106, a die 108 in communication with the feedpipe 107, and a take-up roller device 109 in communication with the die 108. The sample source container can be any component of the plastic extrusion line, including, but not limited to, the crystallizer/drier 101, the hopper 102, the barrel 103, the breaker plate 106, the die 108, and the take-up roller device 109. As the components of the plastic extrusion line (including the crystallizer/drier 101, the hopper 102, the barrel 103, the extruder screw 104, the screw motor 105 the breaker plate 106, the die 108, and the take-up roller device 109) are well known in the relevant field, those components are not described in detail in this disclosure. Rather, each of these components may have any suitable structure and configuration that is known in the art.

To analyze the sample, the system 100 takes the sample from the sample source container and delivers the sample to the detector 160. In some embodiments of the present invention, the sample is delivered to the detector 160 from the sample source container (e.g., the hopper 102) via a pump 167 in communication with the sample source container and the detector 160. The pump 167 may be any device suitable for pumping a gaseous sample from the sample source container to the detector 160. In some embodiments, the pump may be configured to continuously pump gas from the sample source container to the detector throughout the entire extrusion process. In such embodiments, the pump 167 may be programmed or configured to pump gas from the sample source at a specific gas flow rate determined, at least in part, by the plastic feedstock material used in the extrusion process and the type of detector(s). For example, in some embodiments of the present invention, the pump 167 is configured to continuously pump gas from the sample source container to the detector 160 at a continuous rate that may be determined based on the type of detector used. Flow rates may range from about 100 to about 2,000 cc/min. For example, the optimum flow rate for a photoionization detector will be about 550 to about 650 cc/min. In another example, the optimum flow rate for a combination of a photoionization detector and a flame ionization detector will be about 950 to about 1,000 cc/min. In another example, a flow rate of about 600 cc/min proved sufficient for the photoionization detector. Although the pump may be continuously supplying gas from the sample source container to the detector 160, in some embodiments, the detector 160 is configured to collect data from the gas at regular time intervals. For example, the detector may be programmed or configured to collect data regarding the gas every 30 to 300 seconds. In some embodiments, for example, the detector 160 may be programmed or configured to record data every 40 to 90 seconds, for example, every 60 seconds. Alternatively, the pump 167 may be coupled to a controller 168 which controls delivery of power to the pump 167. In this configuration, the controller 168 may be programmed to turn the pump on or off at regular time intervals. For example, in some embodiments, the controller 168 may be programmed to turn the pump 167 on every 60 seconds and off every 90 seconds, so that the pump 167 runs for a period of 30 seconds before it is turned off again. It is to be understood, however, that these time intervals are presented for illustrative purposes only, and are in no way limiting. Indeed, the controller 168 can be programmed to turn the pump 167 on and off at any time intervals. The on-time requirement for the pump will depend on the distance from the sample source. The pump may be on for periods as short as 12 seconds, or as long as one minute, when cycling on and off The periods between pump cycles may be as short as 8 seconds to as long as 10 minutes.

To deliver the sample from the sample source container to the detector 160, the system 100 further comprises a conduit 130. The conduit 130 connects the sample source container to the detector 130, and may have any suitable structure and configuration. For example, in some embodiments, the conduit is a pipe or tube connecting the sample source container to the detector 160. The pipe or tube may be made of any suitable material, and in some embodiments, for example, the pipe or tube is made of copper. The conduit may also be constructed of stainless steel, polyethylene, polyurethane, vinyl, or any other suitable material. Additionally, the conduit (e.g., pipe or tube) may be of any size. For example, in some embodiments, the conduit is a pipe or tube having an inner diameter of about 1/16 inch. Typically, the conduit would have an inner diameter of about 1/16 to about ½ inch. In some embodiments, the conduit 130 may be temperature controlled to inhibit the condensation of VOCs in the line prior to sample analysis. As condensation of VOCs in the line can result in contamination and cause false readings, prevention of such condensation ensures more accurate analysis results. To deliver the gas from the sample source container to the detector 160, the conduit 130 has an inlet in the sample source container and an outlet to the detector 160. In some embodiments, the conduit is plumbed into the sample source container (e.g., the hopper 102 or the crystallizer/drier 101) so that the inlet of the conduit 130 is submerged in the plastic source material (e.g., the feedstock material). Also, in some embodiments, when the sample source container is the hopper 102, the conduit is plumbed into the hopper 102 such that the inlet is distanced from the top of the extruder screw 104. In some embodiments, for example, the inlet is distanced from the extruder screw by about 2 inches. However, this distance can be less than 1″ to as much as 48″, depending on the hopper configuration.

In some embodiments, the outlet of the conduit 130 communicates with a filter 170, such that the sample gas reaches and passes through the filter prior to reaching the detector 160. Any suitable material for the filter 170 may be used, and in some embodiments, the filter 170 is a polytetrafluoroethylene (PTFE) material. The filter material may also be polypropylene, porous metal fiber, or any other suitable material. The filter serves to insulate the detector from intense heat and off-gassing passing through the conduit 130 from the extrusion line.

In some embodiments, the system 100 may further include a chromatography column (CC) 175 between the outlet of the conduit 130 and the detector 160. In embodiments including a filter 170, the chromatography column 175 is between the filter 170 and the detector 160. Chromatography columns are well known in the relevant field, and therefore, will not be discussed in detail in this disclosure. Also, while the chromatography column 175 may be used in embodiments employing any type of detector 160, the chromatography column 175 may be particularly useful with photoionization detectors as a means of increasing the selectivity of that type of detector. In addition, while any chromatographic column technique may be used, one nonlimiting example of a suitable chromatography column is a gas chromatography column.

As discussed above, the outlet of the conduit 130 is in communication with the detector 160 either directly, or indirectly via the filter 170 and/or the chromatography column 175. The detector 160 may be any suitable detector, i.e., the detector 160 may have any suitable structure or configuration. In some embodiments, for example, the detector 160 is a photoionization detector, a flame ionization detector, or a mass spectrometer (e.g., a portable mass spectrometer). As the structure, configuration and operation of photoionization detectors, flame ionization detectors and mass spectrometers (including portable mass spectrometers) are well known in the relevant art, detailed descriptions of those devices are not presented in this disclosure. In some exemplary embodiments, however, a photoionization detector having a resolution of about 0.1 ppm may be used.

While the detector 160 can be a single type of detector (e.g., a photoionization detector or a flame ionization detector), in some exemplary embodiments, the detector 160 can include any combination of two or more types of detectors. For example, in some embodiments, the detector 160 includes both a photoionization detector and a flame ionization detector, both a photoionization detector and a mass spectrometer, both a flame ionization detector and a mass spectrometer, or all of a photoionization detector, flame ionization detector, and mass spectrometer. However, as would be understood by those of ordinary skill in the art, when a combination of detector types is used, and the combination includes a flame ionization detector, the flame ionization detector is the last detector to receive the gas sample. Indeed, as flame ionization detectors typically consume most, if not all of the components they detect, those types of detectors ought to be the last detectors in any sequence of two or more detector types. In some embodiments, for example, the detector is a combination of a photoionization detector and a flame ionization detector. In some exemplary embodiments of such a combination of detectors, the photoionization/flame ionization detector may have a repeatability of ±1% and ±2% for the photoionization detector and flame ionization detector, respectively.

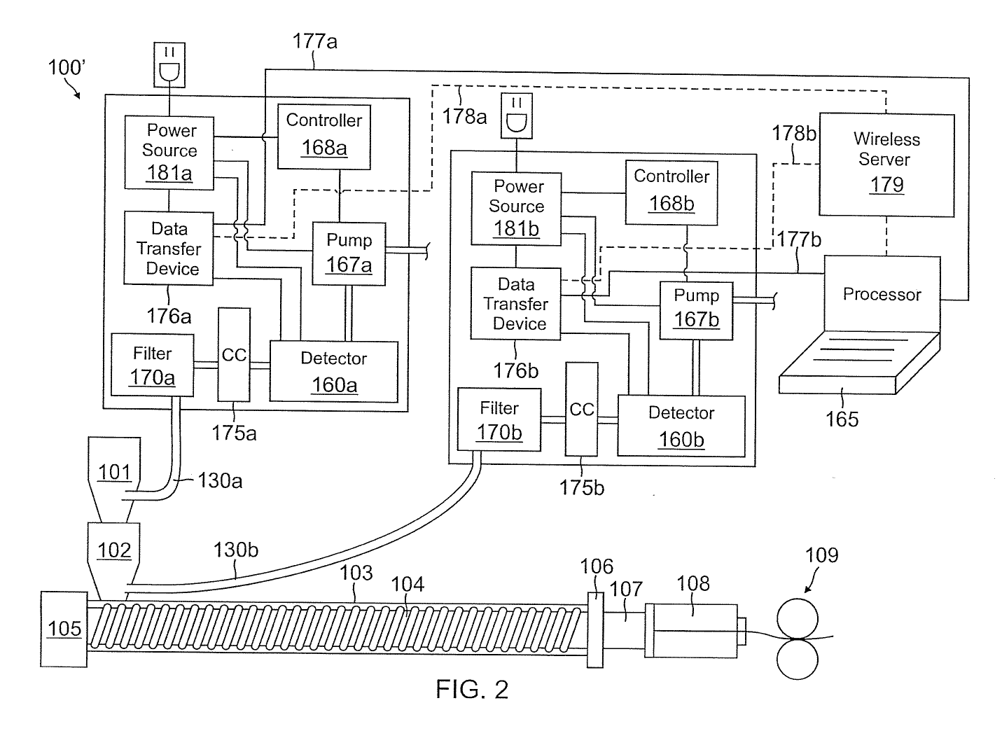

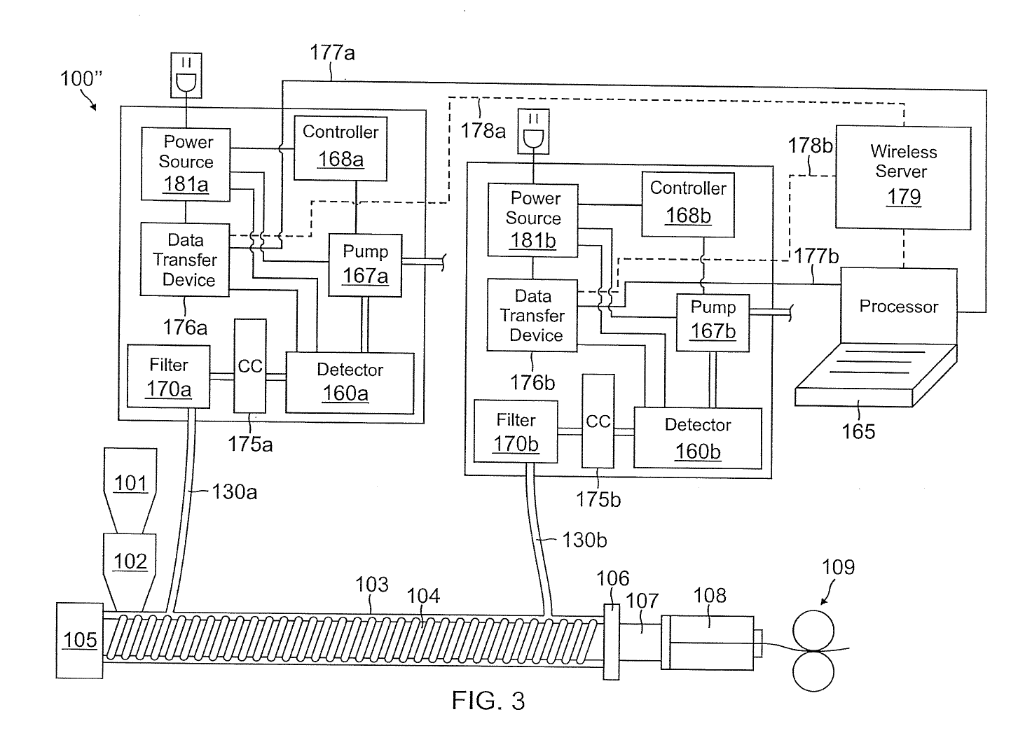

According to some embodiments of the present invention, the system 100 further includes a data transfer device 176 in communication with the detector 160. The data transfer device 176 receives data from the detector 160 and transfers the data to a processor 165 (e.g., a computer) via either a wired 177 or wireless 178 connection. Although the drawings depict both a wired 177 and wireless 178 connection, it is understood that these depicted connections are alternatives to one another, and that, although it is possible, it is unlikely and unnecessary for a system with a single data transfer device 176 to include both types of connections. However, in embodiments with two or more data transfer devices 176, such as those depicted in FIGS. 2 and 3 (discussed in further detail below), one of the data transfer devices 176 may be connected to the processor 165 via a wired 177 connection while another of the data transfer devices 176 may be connected to the processor 165 via a wireless connection 178.

In embodiments in which the data transfer device 176 is connected to the processor via a wireless connection 178, the system may further include a wireless server 179 for receiving data via the wireless connection 178 from the data transfer device and for providing access to the data by the processor 165. In some embodiments, the wireless transfer of data from the data transfer device 176 to the processor 165 occurs via the internet. In particular, the data transfer device 176 uploads the data received from the detector 160 to the internet, the wireless server 179 receives the information via the internet, and the processor 165 downloads the data for analysis. While either a wired 177 or wireless 178 connection can be used, the wireless connection 178 provides the added benefit of being able to send (or download) the data from the detector 160 (via the data transfer device 176 and/or the wireless server 179) to a computer remote from the extrusion line.

The system 100 also includes a processor 165 for receiving and analyzing data from the data transfer device 176. The processor 165 may be any suitable device capable of receiving and analyzing data from the data transfer device 176. In some embodiments, for example, the processor 165 is a computer or other computational device. As discussed above, the processor may be connected to the data transfer device 176 via a wired 177 or wireless 178 connection. As such, the processor may be connected to the system, or may be remote from the system and communicate with the system via the wireless connection 178. Also, as discussed in further detail below, the processor has an internal memory in which is stored an empirical model that includes data points regarding measured total extractables and evolved VOCs (measured during extrusion) of commercially available feedstock materials (or other control materials). This empirical model is used by the processor as a control to which data taken during future extrusion processes are compared. The processor 165 uses that comparison data to predict (prior to completion of the extrusion process) the amount of total chemical extractables (or chemical migration) that will be in the finished, extruded product. Accordingly, in embodiments of the present invention, the processor 165, using the stored empirical model, is able to predict (prior to completion of the extrusion process) what the level of chemical extractables (or chemical migration) will be in the finished, extruded product, and therefore predict (prior to completion of extrusion) whether the finished product will satisfy threshold requirements (such as, for example, the requirements set forth in the Code of Federal Regulations).

The system 100 also includes a power source 181 for powering the various components of the system 100. For example, the power source 181 can be used to power the controller 168, pump 167, detector 160, and data transfer device 176. Alternatively, the system may include separate power sources for each component. Additionally, in embodiments of the present invention, the extrusion line (e.g., the screw motor) is powered by a separate power source, and the processor 165 and/or wireless server are also powered by separate power sources.

In other embodiments of the present invention, as shown in FIG. 2, the system includes at least two conduits, where each conduit connects a different sample source container to a separate detector. For example, as shown in FIG. 2, a first conduit 130a may connect the crystallizer/drier 101 to a first detector 160a. As discussed above with reference to FIG. 1, the first conduit 130a may be either directly in communication with the first detector 160a, or indirectly in communication with the first detector 160a via a first filter 170a and/or a first chromatography column 175a. In the embodiment shown in FIG. 2, the system 100′ further includes a second conduit 130b connecting the hopper 102 to a second detector 160b. As described above with respect to the first conduit, the second conduit 130b may be either directly in communication with the second detector 160b, or indirectly in communication with the second detector 160b via a second filter 170b and/or a second chromatography column 175b. All of the components depicted in FIG. 2 are analogous to the corresponding components depicted in FIG. 1 and described above. For example, the first and second detectors 160a and 160b in FIG. 2 are analogous to the detector 160 in FIG. 1, and the first and second detectors 160a and 160b may have the same or similar construction and configuration as the detector 160 described above. Similarly, the remaining components depicted in FIG. 2 may have the same or similar construction and configuration as their corresponding components in FIG. 1. However, to differentiate the system 100 in FIG. 1 from the system 100′ in FIG. 2, the components in system 100′ have been labeled with “a” or “b” in order to denote that the system 100′ includes two of those components.

In alternative embodiments, as shown in FIG. 3, the at least two conduits can connect different portions of the same sample source container to separate detectors, e.g., a first conduit 130a′ may connect a first end of the barrel 103 to a first detector 160a′, and a second conduit 130b′ may connect a second end of the barrel 103 to a second detector 160b′. As described above with respect to FIG. 2, the first conduit 130a′ and second conduit 130b′ may be either directly in communication with the first or second detector 160a′ or 160b′, or indirectly in communication with the first or second detector 160a′ or 160b′ via a first or second filter 170a′ or 170b′ and/or a first or second chromatography column 175a′ or 175b′. All of the components depicted in FIG. 3 are analogous to the corresponding components depicted in FIGS. 1 and 2 and described above. For example, the first and second detectors 160a′ and 160b′ in FIG. 3 are analogous to the detector 160 in FIG. 1 and the detectors 160a and 160b in FIG. 2, and the first and second detectors 160a′ and 160b′ may have the same or similar construction and configuration as the detector 160 described above. Similarly, the remaining components depicted in FIG. 3 may have the same or similar construction and configuration as their corresponding components in FIGS. 1 and 2. However, to differentiate the systems 100 and 100′ in FIGS. 1 and 2 from the system 100″ in FIG. 3, the components in system 100″ have been labeled with “a”' or “b”' in order to denote that the system 100″ includes two of those components.

Additionally, in embodiments in which the conduit 130, 130a, 130b, 130a′ or 130b′ is connected to the barrel 103, the inlet of the conduit is plumbed into the barrel 103 such that the inlet is distanced from the extruder screw 104. For example, the inlet of the conduit 130, 130a, 130b, 130a′ or 130b′ is distanced from the extruder screw 104 by about ½″. The inlet may be at the surface of the screw, or distanced by as much as 1″.

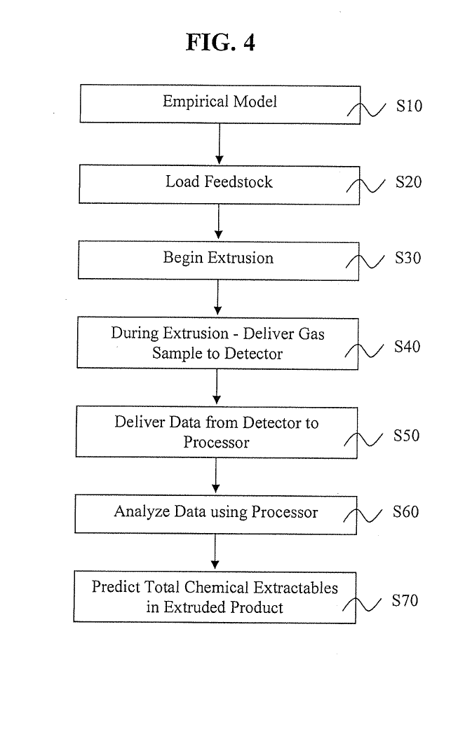

In alternative embodiments of the present invention, as shown in FIG. 4, a method of predicting the amount of chemical extractables in an extruded product includes calibrating the above-described system with a baseline (or threshold) model (also referred to herein interchangeably as an “empirical model”) (S10), loading a feedstock material into a sample source container of an extrusion device (S20), performing an extrusion process on the feedstock material (S30), delivering at least one sample gas from at least one sample source container in the extrusion line to a detector (S40) during extrusion, delivering data about the sample gas from the detector to a processor (S50) during extrusion, analyzing the data about the sample gas using the processor (S60), and predicting the amount of chemical extractables in the extruded product based on the analysis of the processor (S70).

### Creating the Empirical Model

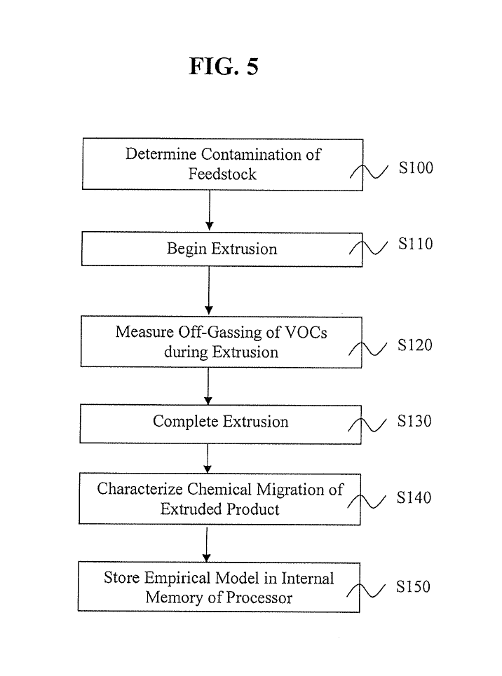

As shown in FIG. 5, to calibrate the system with an empirical model (i.e., a baseline or threshold model), the level of contamination in the plastic feedstock (or source) material is first determined (S100). Then, extrusion is begun (S110), and the amount of evolved VOCs is determined (S120) at at least one point during the extrusion process. For example, an amount of evolved VOCs may be determined by collecting a gaseous sample from the exhaust of the crystallizer/drier and/or the hopper, and analyzing the amount of VOCs in the sample using the system described above. Finally, the extrusion process is completed (S130), and the resulting extruded product is analyzed to determine and quantify the extent of chemical migration into a food simulant (i.e., the amount of chemicals desorbed from the extruded product into a food simulant is determined) (S140). Upon completion of these measurements, the empirical model is completed and the data collected is stored in the internal memory of the processor (S150) for use as a control in analyzing data taken from future extrusion processes using the inventive system described above.

### Determining the Level of Contamination in the Plastic Feedstock

The level of contamination in the plastic feedstock can be determined by any suitable method or technique. However, in preparing the empirical model in embodiments of the present invention, the present inventors developed a method for determining and quantifying the level of contamination in a plastic feedstock material. This method is herein referred to as a “gravimetric reflux method.” The gravimetric reflux method includes adding a solvent to a sample of the feedstock material, and refluxing the mixture for a suitable period of time (for example, between 6 and 24 hours). After reflux, a sample of the refluxed mixture may be removed for analysis, but the remainder of the mixture is filtered into an evaporation dish (e.g., via a coarse filter), and heated to a boil. The sample is boiled until all the solvent has evaporated, and then the dish is weighed. The difference in mass between the empty evaporation dish (i.e., prior to adding the refluxed mixture) and the evaporation dish after solvent evaporation represents the mass of the chemical extractables from the feedstock material.

In the gravimetric reflux method described above, the solvent added to the feedstock material may be any solvent suitable for determining desorbtion of chemicals from the feedstock into a food simulant. As such, the solvent should be a food simulant, such as, for example, water, a solution of ethanol in water or n-heptane. In some embodiments, for example, the solvent is nanopure water, an 8% solution of ethanol in nanopure deionized water, and n-heptane. However, it is understood that although these solvents are useful in determining the migration of chemicals in the plastic feedstock materials, they are not the only solvents useful for this purpose. Instead, any solvent capable of simulating a food may be used in this gravimetric reflux method.

Also, as would be understood by those of ordinary skill in the art, the temperature of the heat used to bring the solvent mixture to a boil and drive off the solvent will vary depending on the solvent used. Indeed, those of ordinary skill in the art would be capable of selecting an appropriate temperature to drive off the solvent.

The following exemplary gravimetric reflux method is presented for illustrative purposes only, and does not limit the scope of this invention.

### Exemplary Gravimetric Reflux Method

30 grams of PET flake was added to a 250 mL round bottom flask. Solvent was added (100 mL of either nanopure water, 8% ethanol in nanopure water, or n-heptane), and the mixture was allowed to reflux for 12 hours. After refluxing the system, a 10 mL aliquot was removed and saved for analysis. The remaining 90 mL was poured through a coarse filter into a tared evaporation dish. The round bottom flask was rinsed twice with 10 mL of solvent and poured through the filter. The solvent was poured into the evaporation dish, placed on a hot plate, and brought to a boil. To minimize error in mass measurement of the extractables, a small evaporation dish was used (<50 mL). Thus, solvent was poured from the round bottom flask into the dish several times to completely evolve the solvent. Another small aliquot of solvent, 0.5 mL, was removed for analysis while there was 5 mL of solvent remaining in the evaporation dish after all of the solvent was added to evaporate. Once all of the solvent boiled off, the evaporation dish was weighed. The mass increase between the tared (and empty) evaporation dish and the evaporation dish resulting from the reflux method corresponds to the mass of the extractables from the flake (with corrections made for the two aliquots which were removed).

Although the gravimetric reflux method is described here as useful in determining the total extractables from the plastic feedstock material, it is understood that this method may also be used to determine the total extractables from the extruded product (after completion of extrusion). Additionally, it is understood that the method for determining total extractables from the extruded product (discussed below) may also be used to determine the total extractables from the plastic feedstock material. Also, the solvent extraction and headspace analysis techniques/methods discussed below with respect to determining the amount of off-gassing during extrusion can also be used to determine the amount of chemical extractables in the feedstock material or the extent of chemical migration or total extractables in the finished, extruded product. Indeed, it is understood that while the specific methods and techniques discussed here can be used to create the empirical model for use as a control in the system described above, any combination or rearrangement of these techniques and methods can be used to create the empirical model.

### Characterizing Chemical Migration in the Extruded Sheet

The total extractables (or chemical migration) in the finished, extruded product may be measured or determined by any suitable method or technique. For example, any of the above or below techniques may be used, including, but not limited to the gravimetric reflux method, solvent extraction, headspace analysis, and/or GC-MS. However, in order to more accurately predict compliance or non-compliance with Code of Federal Regulations requirements, in some embodiments, the total chemical extractables (or chemical migration) of the finished, extruded product (for use in the empirical model) is determined by the process outlined in the Code of Federal Regulations. Additional details regarding the Code of Federal Regulations method can be found in the Code of Federal Regulations (CFR) at Title 21, Chapter 1, Subchapter B, Part 177, the entire content of which is incorporated herein by reference.

The following examples are presented for illustrative purposes only, and do not limit the scope of the present invention.

Exemplary CFR Procedure for Determining Total Extractables from Extruded Sheet

Each specimen (i.e., extruded plastic product) was analyzed for chemical migration according to Title 21, Chapter 1, Subchapter B, Part 177 of the Code of Federal Regulations. 21 CFR §177 states that a package must not desorb more than 0.5 mg of total chemicals per square inch into food simulants. The specified food simulants are nanopure deionized water, an 8% ethanol solution in nanopure deionized water, and n-heptane.

A circular disk was cut from each extruded sheet. Each extruded sheet was made of a particular type of flake samples or virgin resin, or a mixture thereof and corresponds to a signal from the hopper and crystallizer/drier. The size of the extruded sheet was slightly larger than the area of exposure to ensure a good seal between the specimen and the analysis apparatus. The area of exposure to the food simulants in this case was 6.61 in² for each specimen. Disks were conditioned according to ASTM D618-08 using a Thermo-Forma Scientific environmental chamber coupled to 982 series controllers (made by Watlow, Winona, Minn.). Conditioning continued until the mass of each disk was within +/−0.1 mg for three consecutive measurements (the masses were recorded approximately every twenty-four hours). The mass of each disk was determined using a Model AB 104 scale (made by Mettler Toledo, Columbus, Ohio) with a resolution of +/−0.1 mg.

The specimens were tested using common glass Mason jars. Polytetrafluoroethylene tape was placed around the mouth and over the lip of each jar. The jars were filled with 100 mL of the corresponding food simulant and specimens were placed on the PTFE-lined jar lips such that the food contact side of the specimens would be exposed to the food simulants once the jars were inverted. The specimens were then secured in place with the jar metal locking rings.

To test for total migration, the jars were inverted and placed in a Model 750F oven (made by Fisher Scientific, Pittsburg, Pa.) at 49° C. for 24 hours. After 24 hours, the specimens were removed from each jar, wiped clean, and then placed in an environmental chamber for conditioning according to ASTM D618-08.

### Determining the Level of VOC Off-Gassing (Evolution)

To determine the level of VOC evolution that occurs during extrusion, the system described above may be used. Specifically, a sample may be collected from a conduit(s) plumbed into any component(s) along the extrusion line, e.g., the crystallizer/drier and/or hopper. The sample may then be analyzed by any suitable means, for example, photoionization detection, flame ionization detection and/or mass spectrometry to determine the level of VOC off-gassing (or evolution) during extrusion. To prepare a more complete and accurate empirical model, different feedstock materials may be used, including different plastic flake samples (e.g., from Global, Merlin, and E.J. Wright) as well as virgin resin samples (e.g., from Eastman, Arya and ZPET). The following examples are presented for illustrative purposes only, and do not limit the scope of the present invention.

A. Exemplary Procedure for Obtaining Drier/Crystallizer Signal

Copper wire tubing ( 1/16 inch inner diameter) was plumbed into a Farragtech 40 Compressed Air Resin Drier (CARD) E material drier such that the inlet of the tubing would be submerged into the material when in use. The outlet of the tubing was mounted to a PTFE filter connected to an analyzer including a photoionization detection (PID) analyzer with a resolution of 0.1 ppm or a PID/Flame Ionization Detection (FID) with repeatability of ±1% and ±2% for the PID and FID, respectively.

The material drier was set to 160° C. and allowed to equilibrate. The analyzing unit was initiated and allowed to equilibrate for at least five minutes before the sample was loaded into the machine. The exact time was noted as the material was loaded into the drier and was allowed to dry for exactly four hours. The analyzer was configured to record the amount of volatile organic compounds evolved from the material in the drier in parts per million (ppm) every 60 seconds and had an air inlet flow rate of 500 cc/min for the PID system and 850-1250 cc/min for the PID/FID system. The output signal was transferred to a computer in “real time” and then analyzed. The copper tubing was temperature controlled to inhibit the condensation of VOCs in the line prior to being analyzed.

B. Exemplary Procedure for Obtaining Signal from the Hopper

Copper wire tubing ( 1/16 inch inner diameter) was plumbed into the hopper of the extruder such that the inlet of the tube is spaced from the top of the hopper, e.g., the tubing is located approximately 0 to 1 inch from the top of the screw. The outlet of the tubing was mounted to a PTFE filter attached to the analyzer (which includes the detector) such that the analyzer was away from intense heat and off-gassing caused by the extruder. As the same analyzer was used (i.e., the same analyzer as that used in the above example for obtaining the crystallizer/drier signal), the analyzer included a photoionization detection (PID) analyzer with a resolution of 0.1 ppm or a PID/Flame Ionization Detection (FID) with repeatability of ±1% and ±2% for the PID and FID, respectively.

The analyzer was configured to record the amount of VOCs evolved from the material in the hopper in parts per million (ppm) every 60 seconds and had an air inlet flow rate of 500 cc/min for the PID system and 850-1250 cc/min for the PID/FID unit. The output signal was transferred to a computer in “real time” and analyzed. The copper tubing was temperature controlled to inhibit the condensation of VOC in the line prior to being analyzed.

Using the above settings, the system was then tested. Specifically, the extruder was set to have the heat profile listed below:

Barrel Heat zone 1: 490 degrees F.

Barrel Heat zone 2: 495 degrees F.

Barrel Heat zone 3: 500 degrees F.

Die: 510 degrees F.

The data collected at the crystallizer/drier and hopper was used in creating the empirical model. Also, the extrusion process was run at the above settings using different starting materials (i.e. feedstock materials) to create more data points for the empirical model. Specifically, various sources of recycled flake samples were used, including flake samples from Global, Merlin, and E.J. Wright. Additionally, for comparative testing, the extrusion process was repeated at the above settings using virgin resin samples, including samples from Eastman, Arya, and ZPET.

To create the empirical model, the data collected from these procedures is correlated to data collected from performing headspace analysis, solvent extraction or gravimetric reflux (as described above) on the feedstock material, in some embodiments followed by GC-MS analysis. The correlation is calculated using the standard formula, Corr(x,y)=cov(x,y)/(δₓ,δ_{y}). As would be understood by those of ordinary skill in the art, “cov” refers to the covariance of the stored data and the measured data, “x” and “y” refer to the stored data and measure data, respectively or vice versa, and “δₓ” and “δ_{y}” refer to the standard deviations of the stored data and measured data, respectively or vice versa.

In the solvent extraction method, for example, the feedstock material is placed in a Soxhlet extraction apparatus, and a solvent is placed in the solvent reservoir. The extraction apparatus is allowed to reflux for about 6-24 hours. After reflux, the solvent is cooled and reduced, e.g., under vacuum. When about 5 ml of solvent remains in the apparatus, it may be transferred to a scintillation vial where the rest of the solvent is evaporated. The difference in mass between the empty vial and the vial after evaporation corresponds to the mass of extractable materials in the feedstock (e.g., polyethylene terephthalate flake). After weighing the scintillation vial, solvent may be added back to the vial to prepare the vial for GC-MS analysis.

In the headspace analysis method, the feedstock material is placed in a vial and hermetically sealed with, for example, a polytetrafluoroethylene septum. The vial is placed in the headspace sample of a GC-MS. The GC-MS injects the gas from the headspace of the vial into a gas chromatograph which separates the components of the headspace gas and directs them to a mass spectrometer for analysis.

The following examples are presented for illustrative purposes only, and do not limit the scope of the present invention.

### Exemplary Procedures for Speciation of Evolved Volatile Organic Compounds via Gas Chromatography-Mass Spectroscopy

The following examples are presented for illustrative purposes only, and do not limit the scope of the present invention.

### I. Preparation of Vials for GC-MS Analysis

A. Solvent Extraction

The polyethylene terephthalate species obtained above was blended into flake and a known mass (±0.1 mg) of the flake was placed into a soxhlet extraction apparatus. A typical extraction utilizes ˜25 grams of flake. A solution of 8% ethanol in nanopure water (˜200 mL) was placed into the solvent reservoir. The soxhlet extraction apparatus was allowed to reflux for 6 hours. After the reflux time, the solvent was cooled and reduced under vacuum. When a minimal volume of solvent (˜5 mL) remained, it was quantitatively transferred into a scintillation vial of known mass (±0.02 mg) and the remainder of the solvent was evaporated under vacuum. The vial was weighed again and the increase in mass corresponded to the mass of extractable materials from the PET flake. The extractable material was reported inμg of contaminants per gram of PET flake.

Solvent can be added to the scintillation vial to be used for the GCMS procedure.

B. Headspace Analysis

2 grams of polyethylene terephthalate flake was placed into a vial. The flake could be the source material, or it could be the above described species that was blended into flake. The vial was hermetically sealed with a lid containing a Teflon septum. The vial was placed into the headspace sampler of a gas chromatograph-mass spectrometer. The headspace sampler equilibrates the sample at 200° C. for 10 minutes before injection of the gas sample from the headspace of the vial into the gas chromatograph. The gas chromatograph separated the components of the headspace gas via a capillary column (HP-5MS) utilizing a temperature ramp of 30.00° C./min from an initial temperature of 50° C. to a final temperature of 280° C. with a final hold time of 20 minutes. A helium mobile phase and a split injection were used with an MSD outlet. A 2.00 minute solvent delay was used on the mass spectrometer, with mass scan parameters of 29 to 300 m/z.

### II. Gas Chromatography—Mass Spectrometry (GCMS) Analysis

Samples from the gravimetric method, solvent extraction method, or the headspace analyzer method in either water, 8% ethanol in water, or heptane (i.e., food simulant solvents) were analyzed via gas chromatography-mass spectrometry. All separation parameters were identical except for the solvent delay on the mass spectrometer, which was varied according to the sample solvent. A Helium mobile phase and a splitless injection were used for separation via the gas chromatograph. A temperature ramp of 20° C./min from an initial temperature of 100° C. to a final temperature of 320° C. was used to separate the components of the samples. A 1 μL injection volume and a 5% phenyl methyl siloxane (HP-5MS) capillary column was used. The mass spectrometer was run in SCAN mode with scan parameters of 34 to 800 m/z.

Using the data collected from the crystallizer/drier and/or hopper (or other intermediate stages in the extrusion line), and the data collected from solvent extraction, headspace analysis, etc., an empirical model is created and stored in the internal memory of the processor (described above with respect to the system). Specifically, the empirical model is created by correlating the data from the intermediate stages (e.g., from the crystallizer/drier and/or hopper) to the data collected from the gravimetric reflux method, solvent extraction, headspace analysis and/or GC-MS. The empirical model establishes a threshold comparison model in the internal memory of the processor of the system described above. Specifically, as the system described above collects data during extrusion of further samples, the collected data is compared to the empirical model, and the processor uses the comparison data to predict the amount of chemical extractables that will be present in the extruded product after completion of the extrusion process. This is particularly useful in plastic extrusion technologies as the systems and methods of the present invention enable prediction of compliance or non-compliance of an extruded product with the Code of Federal Regulations desorbtion limits (or other threshold limits) prior to completing the extrusion process. As such, if the processor upon comparison of the sample data taken during extrusion with the empirical model stored in its memory predicts that the chemical migration and resulting VOCs of the extruded product will not comply with a threshold limit (e.g., the Code of Federal Regulations limit), the processor may generate an audio and/or visual signal to an operator that the current extrusion process will not yield an extruded product that satisfies the threshold. This “real time” notification to an operator of the extrusion line enables early termination of the extrusion process, saving time and product, thereby decreasing operation costs.

Also, if the processor predicts non-compliance with the threshold requirements, the processor may communicate with the controller of the system to automatically terminate the extrusion process. For example, in response to a signal from the processor, the controller may shut off the power to the extrusion apparatus, or effect other corrections, such as redirecting the plastic materials at any point in the extrusion line. As would be understood by those of ordinary skill in the art, to effect such automatic correction or termination, the processor is in communication with the controller via either a wired or wireless connection.

The preceding description has been presented with reference to certain exemplary embodiments of the invention. Workers skilled in the art and technology to which this invention pertains will appreciate that alterations and changes to the described embodiments may be practiced without meaningfully departing from the spirit and scope of this invention, as defined in the appended claims. It is further understood that the drawings are not necessarily to scale.

Accordingly, the foregoing description should not be read as pertaining only to the precise systems and methods described and illustrated in the accompanying drawings, but rather should be read consistent with and as support to the following claims which are to have their fullest and fairest scope.

What is claimed is:

1. A system for real-time sample analysis during extrusion, the system comprising:
an extrusion line comprising at least one sample source container comprising a gaseous sample for analysis;
at least one detector in communication with the sample source container and configured to receive and analyze the gaseous sample to generate data about the gaseous sample; and
a processor in communication with the detector, the processor programmed to analyze the data about the gaseous sample and to predict an amount of volatile organic compounds in an extruded product based on the analysis of the data about the gaseous sample.

2. The system of claim 1, wherein the sample source container comprises a hopper, a crystallizer, a drier, a die, a take-up roller device, a barrel, a breaker plate, and/or a feedpipe.

3. The system of claim 1, wherein the detector is a flame ionization detector, a photoionization detector, and/or a mass spectrometer.

4. The system of claim 1, further comprising a chromatography column between the sample source container and the detector.

5. The system of claim 4, wherein the chromatography column comprises a gas chromatography column.

6. The system of claim 1, further comprising a conduit connecting the sample source container to the detector.

7. The system of claim 6, wherein the conduit comprises a pipe or tube.

8. The system of claim 6, wherein the conduit is made of copper.

9. The system of claim 6, wherein the conduit is temperature controlled.

10. The system of claim 1, further comprising a filter between the sample source container and the detector.

11. The system of claim 10, wherein the filter comprises a polytetrafluoroethylene material.

12. The system of claim 1, further comprising a pump for pumping the gaseous sample from the sample source container to the detector.

13. The system of claim 12, further comprising a controller for controlling the delivery of power to the pump.

14. The system of claim 1, further comprising a data transfer device in communication with the detector and the processor, wherein the data transfer device is configured to receive the data from the detector and transfer the data to the processor.

15. The system of claim 14, wherein the data transfer device is in communication with the processor by a wired or wireless connection.

16. The system of claim 1, wherein the analysis of the data about the gaseous sample comprises a comparison of the data about the gaseous sample to control data stored in the processor.

17. A method of predicting an amount of extractable volatile organic compounds in an extruded product, the method comprising:
delivering a sample of gas from at least one intermediate stage in an extrusion process to a detector;
analyzing the sample of gas using the detector to obtain data about the amount of volatile organic compounds in the sample of gas;
delivering the data to a processor;
using the processor to compare the data to control data stored in the processor to generate comparison data; and
based on the comparison data, predicting the amount of extractable volatile organic compounds in the extruded product.

18. The method of claim 17, wherein the delivering the sample of gas from the intermediate stage to the detector comprises pumping the sample of gas from a sample source container in an extrusion line through a conduit to the detector.

19. The method of claim 18, wherein the pumping the sample of gas comprises continuously pumping the sample of gas to the detector.

20. The method of claim 17, wherein the delivering the sample of gas to the detector comprises delivering the sample of gas at time intervals to the detector.

21. The method of claim 20, wherein the delivering the sample of gas to the detector comprises pumping the sample of gas through a conduit to the detector using a pump connected to a controller, wherein the controller is configured to control delivery of power to the pump to turn the pump on and off according to the time intervals.
